(19) United States
(12) Patent Application Publication
(10) Pub. No.: US 2014/0355287 A1
(43) Pub. Date: Dec. 4, 2014

(54) AMBIENT VEHICLE LIGHTING UNIT WITH ESD PROTECTION

(71) Applicant: Ford Global Technologies, LLC, Dearborn, MI (US)

(72) Inventors: Behzad Sohizad, Novi, MI (US); Megan May Lovejoy, Dearborn, MI (US); Donald Paul Bilger, Livonia, MI (US); Steven J. Antilla, Brighton, MI (US); Chad A. Widrick, Oak Park, MI (US)

(21) Appl. No.: 13/908,351

(22) Filed: Jun. 3, 2013

(51) Int. Cl. F21S 8/10; F21K 99/00

(52) U.S. Cl. CPC F21S 48/31; F21K 9/00
USPC 362/545; 362/459

(57) ABSTRACT

An ambient vehicle lighting unit is provided and includes a carrier defining an interior volume and having an illuminable portion. A light emitter is disposed in the interior volume and configured to illuminate the illuminable portion and a protective member is disposed on a surface of the carrier and configured to absorb electrostatic discharge when an electrically charged object contacts the surface.

### FIELD OF THE INVENTION

The present invention generally relates to an ambient vehicle lighting unit and more specifically relates to an ambient vehicle lighting unit having protection against electrostatic discharge.

### BACKGROUND OF THE INVENTION

Ambient lighting within vehicles is a popular feature offered by many vehicle manufacturers and current ambient vehicle lighting units are provided on various vehicle structures to enhance the driving experience. Due to concerns associated with electrostatic discharge (ESD), current ambient vehicle lighting units may have drawbacks such as complicated construction and large packaging size. Therefore, there is a need for an ambient vehicle lighting unit that is not hindered by the above-mentioned drawbacks.

### SUMMARY OF THE INVENTION

According to one aspect of the present invention, an ambient vehicle lighting unit is provided and includes a carrier defining an interior volume and having an illuminable portion. A light emitter is disposed in the interior volume and configured to illuminate the illuminable portion and a protective member is disposed on a surface of the carrier and configured to absorb electrostatic discharge when an electrically charged object contacts the surface.

According to another aspect of the present invention, an ambient vehicle lighting unit is provided and includes a carrier defining an interior volume and having an illuminable portion. A printed circuit board is disposed in the interior volume and includes a light emitter configured to illuminate the illuminable portion and circuitry for driving the light emitter. A protective member is disposed on a surface of the carrier and configured to absorb electrostatic discharge when an electrically charged object contacts the surface.

According to another aspect of the present invention, an ambient vehicle lighting unit is provided and includes a carrier incorporated into an interior vehicle structure and having an illuminable portion. A light emitter is operably coupled to the carrier and configured to illuminate the illuminable portion. A protective member is disposed on a surface of the carrier that is exposed to an interior vehicle space, the protective member being configured to absorb electrostatic discharge when an electrically charged object contacts the surface.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective side view of a front vehicle passenger compartment wherein an ambient vehicle lighting unit is exemplarily shown incorporated into an instrument panel and an inner door panel;

FIG. 2 is a perspective side view of one embodiment of the ambient vehicle lighting unit having a carrier with an illuminable portion;

FIG. 3 is a cross-sectional view of the ambient vehicle lighting unit taken along lines III-III of FIG. 2 showing a light emitter disposed in an interior volume of the carrier and a protective member disposed on a surface of the carrier; and

FIG. 4 is a bottom view of the ambient vehicle lighting unit showing a plurality of LEDs spaced along a printed circuit board and configured to emit light towards the illuminable portion.

### DETAILED DESCRIPTION OF THE PREFERRED EMBODIMENTS

As required, detailed embodiments of the present invention are disclosed herein.

However, it is to be understood that the disclosed embodiments are merely exemplary of the invention that may be embodied in various and alternative forms. The figures are not necessarily to a detailed design and some schematics may be exaggerated or minimized to shown function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

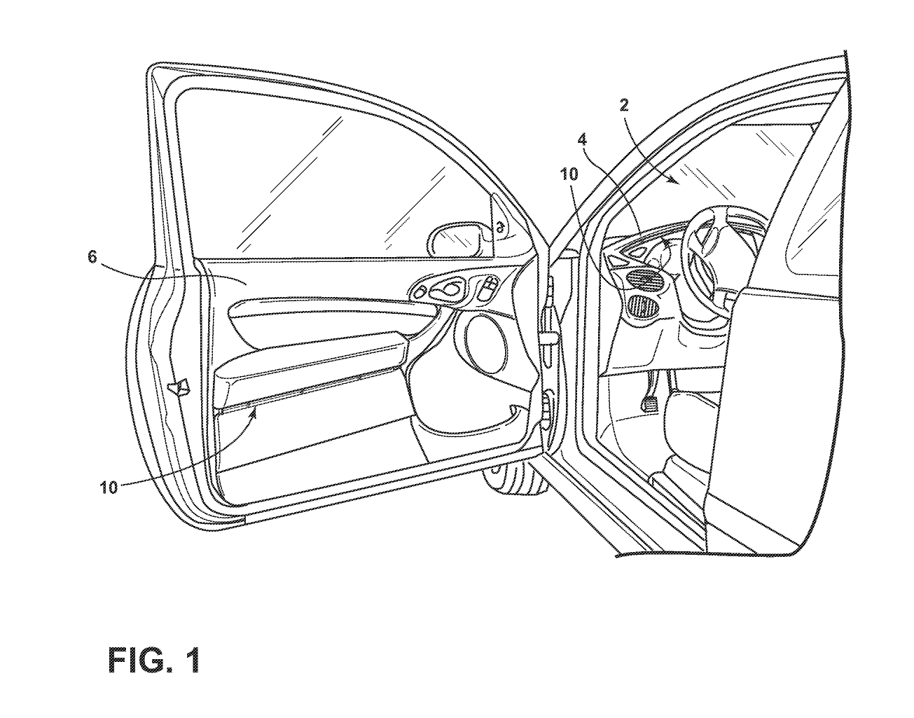

Referring to FIG. 1, a front vehicle compartment 2 is generally shown, wherein an ambient vehicle lighting unit 10 is exemplarily provided on an instrument panel 4 and another ambient lighting unit 10 is provided on an inner door panel 6, both configured to provide ambient light to the vehicle interior. As will be discussed below in greater detail, the ambient vehicle lighting unit 10 benefits from a simple modular design and small packaging size, thus enabling it to be easily adapted to a variety of vehicle structures in addition to those mentioned above to provide ambient lighting within the vehicle interior.

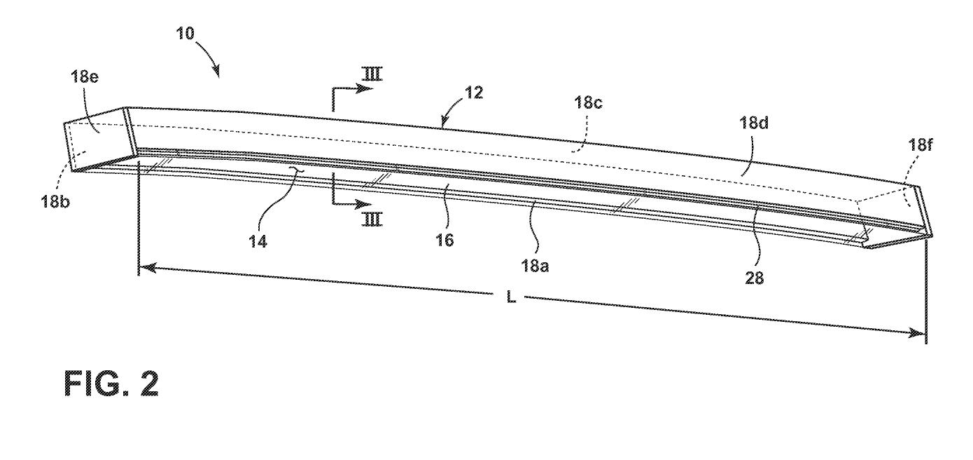

Referring to FIG. 2, an ambient vehicle lighting unit 10 according to one embodiment is shown. The ambient vehicle lighting unit 10 includes a carrier 12 defining an interior volume 14 and having an illuminable portion 16. The carrier 12 is shown having a cuboidal configuration but may be readily embodied in other geometric configurations using the teachings provided herein. As shown, the carrier 12 includes rectangular sides 18a, 18b, 18c, 18d, 18e, and 18f and has a variable length L defined by sides 18a, 18b, 18c, and 18d, wherein side 18a corresponds to the illuminable portion 16.

The illuminable portion 16 includes engagement members 19a and 19b, as shown in FIG.

3, which extend the length of the illuminable portion 16 and extend perpendicularly therefrom to frictionally engage the interior surface of sides 18b and 18d, respectively, thereby removably coupling the illuminable portion 16 to sides 18b and 18d of the carrier 12 to enable the illuminable portion 16 to be easily removed and replaced if necessary. However, those having ordinary skill in the art will readily recognize that other methods exist for securing the illuminable portion 16 to the rest of the carrier 12 and that the illuminable portion 16 may also be permanently joined thereto if desired.

Except for the illuminable portion 16, the carrier 12 of the present embodiment may be constructed from an opaque material such as dark colored polyvinyl chloride (PVC) and the illuminable portion 16 may be constructed from a transparent or translucent material such as colorless PVC to enable light transmission therethrough. If constructed from PVC with high rigidity, the carrier 12 typically embodies a linear configuration. In some instances however, it may be desirable for the carrier 12 to have flexible characteristics. For example, some vehicle structure surfaces may be curved, which may prevent a rigid carrier from being adapted thereto. For these types of situations, PVC having greater plasticity or other types of flexible materials may be used instead.

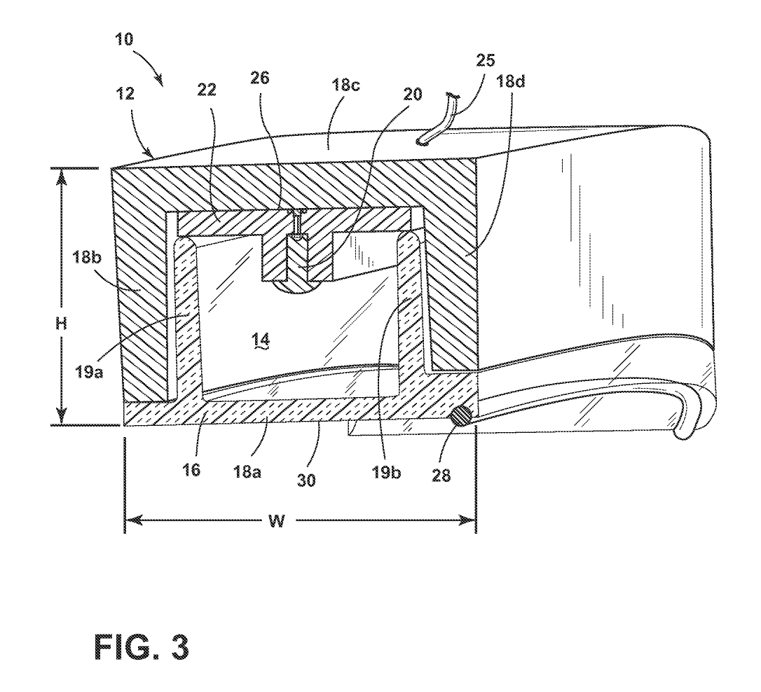

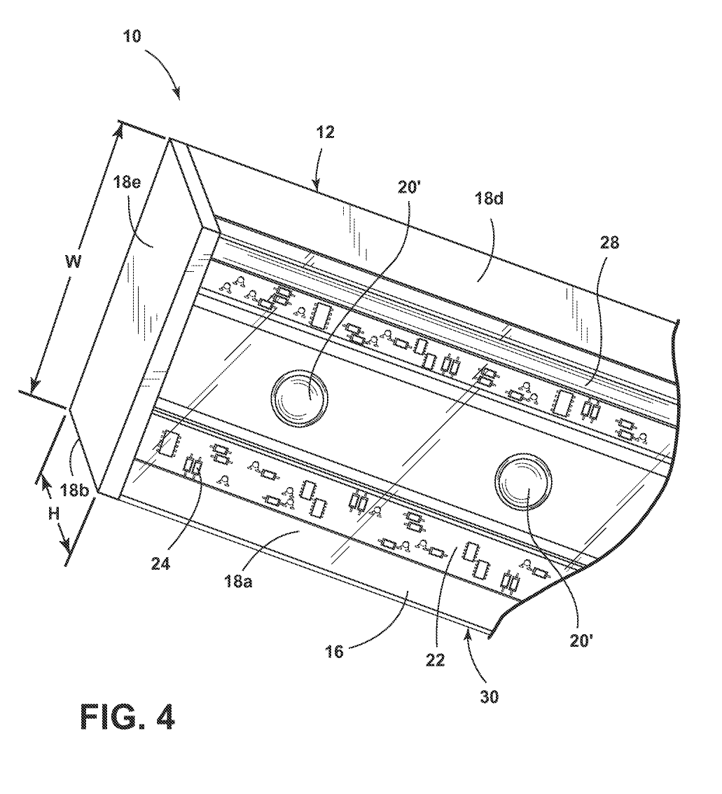

Referring to FIGS. 3 and 4, a light emitter 20 is shown disposed in the interior volume 14 of the carrier 12 and configured to illuminate the transmissive member 16. The light emitter 20 is provided on a printed circuit board 22 (hereinafter PCB) having circuitry 24 thereon for driving the light emitter 20 and is embodied as a row of LEDs 20′ spaced along the length of the PCB 22 as shown in FIG. 4. The LEDs 20′ may be configured to produce a single color or multiple colors and the circuitry 24 may be configured to control a variety of lighting characteristics such as hue, intensity, and/or duration. In addition, the circuitry 24 may be interfaced with vehicle systems via wired and/or wireless communication systems used in vehicles. To drive the LEDs 20′, the circuitry 24 is electrically coupled to a wire 25 that supplies electrical power from an onboard vehicle power source and is typically located on whichever side the PCB 22 is mounted to.

In the present embodiment, the PCB 22 is mounted to an interior surface 26 of side 18c of carrier 12 such that the PCB 22 is disposed opposite to the illuminable portion 16 and the light emitter 20 emits light towards the illuminable portion 16. The PCB 22 extends lengthwise across the interior surface 26 of side 18c of carrier 12 and a flexible PCB may be used with a carrier having a non-linear configuration. The PCB 22 has substantially the same length as the illuminable portion 16 so that the LEDs 20′ can uniformly illuminate the transmissive member 16. Also, the interior surface 26 has substantially the same dimensions as the PCB 22, thereby decreasing the width W of the carrier 12 and the overall packaging size of the carrier 12.

To further minimize the overall packaging size, a protective member 28 is disposed on a surface 30 of the carrier 12 and is configured to absorb electrostatic discharge (ESD) when an electrically charged object contacts the surface 30. The surface 30 corresponds to an area that is exposed to an interior vehicle space once the carrier has been incorporated into a vehicle structure. In the event where an electrically charged object contacts the surface 30, the ambient vehicle lighting unit may be prevented from properly operating. For example, a vehicle occupant having electrical charge accumulated on his or her body may intentionally or accidentally touch the surface 30. Without a form of ESD protection, the electrical exchange between the occupant and the carrier 12 may damage the circuitry 24 in the interior volume 14. As a result, the circuitry 24 must be placed at greater distances from the surface 30 to avoid damage in the absence of the protective member 28. Therefore, by equipping the carrier 12 with ESD protection, the circuitry 24 may be positioned closer to the surface 30 and the circuitry 24 is less susceptible to damage caused by ESD, which in turn allows for a smaller packaging size for the carrier 12.

Generally, when the carrier 12 is incorporated into a vehicle structure, the surface 30 typically corresponds to that of the illuminable portion 16 since it is necessary to expose the illuminable portion 16 to provide ambient light whereas the vehicle structure typically conceals and protects the other surfaces of the carrier 12. Nevertheless, in instances where other surfaces of the carrier 12 are exposed, a protective member similar to the one described herein may be disposed on those surfaces to provide the same protection against ESD.

According to the present embodiment, the protective member 28 is partially embedded in the exterior surface of the illuminable portion 16 and includes an electrically conductive rod-like configuration. The protective member 28 is configured to extend along the length of the illuminable portion 16 and is positioned distally thereon to minimize visual obstruction of ambient light across the illuminable portion 16. The protective member 28 may be constructed from a metallic material such as copper and should have malleable characteristics if using a non-linear carrier configuration. The protective member 28 is grounded to a vehicle chassis or other suitable vehicle ground to discharge static electricity when an electrically charged object contacts the exterior surface of the illuminable portion 16. As a result, the circuitry 24 may be positioned closer to the transmissive portion 16 thereby decreasing the height H of the carrier 12 to minimize the overall packaging size of the carrier 12.

Accordingly, an ambient vehicle lighting unit 10 has been advantageously described herein. The ambient vehicle lighting unit benefits from simple construction, affording a manufacturer the ability to offer the ambient vehicle lighting unit in a variety of shapes and sizes. In addition, the ambient vehicle lighting unit includes protective means against ESD which affords it a smaller packaging size, thus allowing the ambient vehicle lighting unit to be incorporated on a variety of vehicle structures.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. An ambient vehicle lighting unit, comprising:
a carrier defining an interior volume and having an illuminable portion;
a light emitter disposed in the interior volume and configured to illuminate the illuminable portion; and
a protective member disposed on a surface of the carrier and configured to absorb electrostatic discharge when an electrically charged object contacts the surface.

2. The ambient vehicle lighting unit of claim 1, wherein the carrier has a predetermined length and the illuminable portion extends lengthwise along the predetermined length of the carrier.

3. The ambient vehicle lighting unit of claim 1, wherein the light emitter is provided on a printed circuit board, wherein the printed circuit board has circuitry thereon for driving the light emitter and is mounted to an interior surface of the carrier.

4. The ambient vehicle lighting unit of claim 3, wherein the light emitter comprises a plurality of LEDs spaced along the length of the circuit board and configured to uniformly illuminate the illuminable portion.

5. The ambient vehicle lighting unit of claim 4, wherein the printed circuit board is mounted opposite from the illuminable portion such that the light emitter emits light towards the illuminable portion.

6. The ambient vehicle lighting unit of claim 1, wherein the protective member comprises an electrically conductive material and is grounded to a vehicle ground to discharge static electricity.

7. The ambient vehicle lighting unit of claim 1, wherein the protective member is partially embedded in the surface and configured to extend along the length of the surface.

8. The ambient vehicle lighting unit of claim 1, wherein the surface comprises an exterior surface of the illuminable portion and the protective member is positioned distally thereon.

9. An ambient vehicle lighting unit, comprising:
a carrier defining an interior volume and having an illuminable portion;
a printed circuit board disposed in the interior volume and having a light emitter configured to illuminate the illuminable portion and circuitry for driving the light emitter; and
a protective member disposed on a surface of the carrier and configured to absorb electrostatic discharge when an electrically charged object contacts the surface.

10. The ambient vehicle lighting unit of claim 9, wherein the carrier has a predetermined length and the illuminable portion extends lengthwise along the predetermined length of the carrier.

11. The ambient vehicle lighting unit of claim 9, wherein the printed circuit board is mounted to an interior surface of the carrier and the light emitter comprises a plurality of LEDs spaced along the length of the circuit board and configured to uniformly illuminate the illuminable portion.

12. The ambient vehicle lighting unit of claim 11, wherein the printed circuit board is mounted opposite from the illuminable portion such that the light emitter emits light towards the illuminable portion.

13. The ambient vehicle lighting unit of claim 9, wherein the protective member comprises an electrically conductive material and is grounded to a vehicle ground to discharge static electricity.

14. The ambient vehicle lighting unit of claim 9, wherein the protective member is partially embedded in the surface and configured to extend along the length of the surface.

15. The ambient vehicle lighting unit of claim 9, wherein the surface comprises an exterior surface of the illuminable portion and the protective member is positioned distally thereon and is configured to extend along the length of the illuminable portion.

16. An ambient vehicle lighting unit, comprising:
a carrier incorporated into an interior vehicle structure and having an illuminable portion;
a light emitter operably coupled to the carrier and configured to illuminate the illuminable portion; and
a protective member disposed on a surface of the carrier that is exposed to an interior vehicle space, the protective member being configured to absorb electrostatic discharge when an electrically charged object contacts the surface.

17. The ambient vehicle lighting unit of claim 16, wherein the carrier defines an interior volume and the light emitter is provided on a printed circuit board having circuitry thereon for driving the light emitter, wherein the printed circuit board is disposed in the interior volume of the carrier.

18. The ambient vehicle lighting unit of claim 16, wherein the protective member comprises an electrically conductive material and is grounded to a vehicle ground to discharge static electricity.

19. The ambient vehicle lighting unit of claim 16, wherein the protective member is partially embedded in the surface and configured to extend along the length of the surface.

20. The ambient vehicle lighting unit of claim 16, wherein the surface comprises an exterior surface of the illuminable portion and the protective member is positioned distally thereon.
